(19) United States
(12) Patent Application Publication
(10) Pub. No.: US 2017/0103592 A1
(43) Pub. Date: Apr. 13, 2017

(54) AUTOMATED DOOR AND GATE LOCK/UNLOCK

(71) Applicant: Ford Global Technologies, LLC, Dearborn, MI (US)

(72) Inventors: Pietro Buttolo, Dearborn Heights, MI (US); Stuart C. Salter, White Lake, MI (US); Stephen Ronald Tokish, Sylvania, OH (US); James Stewart Rankin, II, Novi, MI (US)

(21) Appl. No.: 14/879,471

(22) Filed: Oct. 9, 2015

(51) Int. Cl. G07C 9/00

(52) U.S. Cl. CPC G07C 9/00039; G07C 9/00309; G07C 9/00015; G07C 2009/00769

(57) ABSTRACT

An access component of a vehicle may be in communication with a plurality of wireless transceivers of the vehicle. The access component may detect a personal device approaching a vehicle door according to signal strength information received from the transceivers, grant access to the vehicle door responsive to receiving a first access code from the personal device, and expire the first access code and issue a second access code to the personal device responsive to the grant. Granting access to the vehicle may include automatically unlocking the vehicle door or automatically opening the vehicle door. The first access code may grant access to a subset of doors of the vehicle, and the second access code may grant access to the same subset of doors.

### TECHNICAL FIELD

Aspects of the disclosure generally relate to automated locking and unlocking of doors or other vehicle openings.

### BACKGROUND

When a driver or other user in possession of a passive entry device approaches a vehicle, a short-range signal from the passive entry device authenticates the user to unlock one or more vehicle doors. Some passive entry systems may also provide for automated locking of doors, as the keyless entry device leaves proximity of the vehicle.

### SUMMARY

In a first illustrative embodiment, a system includes wireless transceivers of a vehicle; and an access component of the vehicle, in communication with the transceivers, programmed to detect, according to signal strength information received from the transceivers, presence of an approaching personal device, grant access to a vehicle door responsive to a first access code received from the personal device, and expire the first access code and issue a second access code to the personal device responsive to the grant.

In a second illustrative embodiment, a method includes authenticating a user with a vehicle using a keyless entry device; issuing a first access code to a personal device responsive to the authenticating; detecting the personal device approaching a vehicle door; granting access to the vehicle via the vehicle door responsive to receiving the first access code from the personal device; and expiring the first access code and issuing a second access code to the personal device responsive to the granting.

In a third illustrative embodiment, a system includes a memory; and a processor, in communication with the memory, programmed to send a first access code stored to the memory to a vehicle to attempt access to the vehicle, receive a second access code responsive to the access being granted, and responsive to receipt of the second access code, discard the first access code and store the second access code to the memory to attempt a later access to the vehicle.

### BRIEF DESCRIPTION OF THE DRAWINGS

FIG. 1A illustrates an example system including a vehicle having a mesh of in-vehicle components configured to locate and interact with users and personal devices of the users;

FIG. 1B illustrates an example in-vehicle component equipped with a wireless transceiver configured to facilitate detection of and identify proximity of the personal devices;

FIG. 1C illustrates an example in-vehicle component requesting signal strength from other in-vehicle components of the vehicle;

FIG. 2A illustrates an example diagram of a user carrying a personal device lacking an access token attempting entry to the vehicle;

FIG. 2B illustrates an example diagram of the user having entered the vehicle receiving the access token granting the carrier of the personal device with access rights to the vehicle;

FIG. 3A illustrates an example diagram of multiple users within the vehicle having personal devices with access tokens granting the personal devices different levels of access rights to the vehicle;

FIG. 3B illustrates an example diagram of users attempting to regain access to the vehicle;

FIG. 4A illustrates an example diagram of a user being granted access to doors of the vehicle using an access token having front seat level permissions;

FIG. 4B illustrates an example diagram of a user being denied access to doors of the vehicle using an access token having rear seat level permissions;

FIG. 4C illustrates an example diagram of a user being granted access to a door of the vehicle using an access token having rear seat level permissions;

FIG. 5 illustrates an example diagram of specific doors of the vehicle automatically being locked when users exit the vehicle;

FIG. 6 illustrates an example diagram of the vehicle automatically being locked when the last user exits the vehicle;

FIG. 7A illustrates an example diagram of a vehicle including a user and contents to which the user may be alerted if left in the vehicle;

FIG. 7B illustrates an example diagram of a vehicle providing an alert to the user that the contents are left in the vehicle;

FIG. 8 illustrates an example process for issuing an access token to a personal device; and

FIG. 9 illustrates an example process for utilizing the access token for re-entry to the vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Vehicle interior modules, such as reading lights or speakers, may be enhanced with a wireless communication interface (such as Bluetooth Low Energy (BLE)). These enhanced modules of the vehicle interior may be referred to as in-vehicle components. Vehicle occupants may utilize their smartphones or other personal devices to wirelessly control features of the in-vehicle components using the communication interface. In an example, a vehicle occupant may utilize an application installed to the personal device to turn a reading light on or off, or to adjust a volume of a speaker.

Signal strength of wireless connections between the personal device and a plurality of the in-vehicle components may be used to determine a location of the personal device. In an example, the plurality of the in-vehicle components may identify signal strength information from the user's personal device, and use the received signal strength information to determine whether the user is located inside or outside of the vehicle. Changes in the signal strength may also be used to determine whether the personal device is approaching the vehicle or departing from the vehicle. In some examples, the change in signal strength over time may be extrapolated in an attempt to identify a vehicle door that the user is attempting to access.

A user carrying the personal device may authenticate with the vehicle using an authentication mechanism such as a key, a key-fob, or entry of a passcode into a vehicle keypad. Once authenticated, the user may be granted access to the vehicle and may settle into one of the seating positions or zones. When the personal device is recognized by the in-vehicle components as being inside the vehicle, a one-time-use access code may be provided to the personal device by an access component. The access token may accordingly be saved to the user's personal device. When the user attempts to re-enter the vehicle at a later time, the access token may be provided to the vehicle by the personal device.

The access token may be indicative of access rights that that are set based on the zone of the user. As an example, if the user is located within a driver zone or front row of the vehicle, the access token may provide the user with access rights to re-enter the front row and other rows of the vehicle. As another example, if the user is located within the second row, the access token may provide the user with access rights to re-enter the second row but not to enter the front row.

When the personal device of a user is detected by the in-vehicle components as attempting to re-enter the vehicle, the access component may grant the personal device vehicle access in accordance with the permissions of the stored access token. When access is granted, the access token may be consumed and a new access token may be provided to the personal device. As the access token is recreated for each successive authentication, the access token may be immune to replay attacks in which an intruder attempts to reuse an access token to gain entry the vehicle.

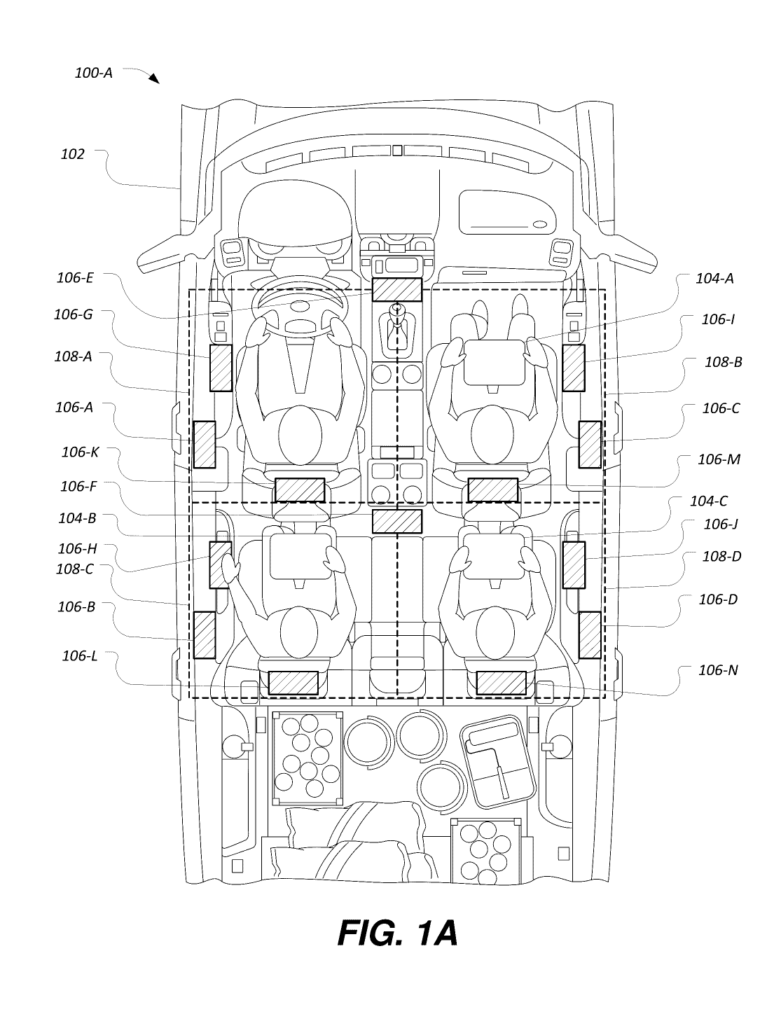

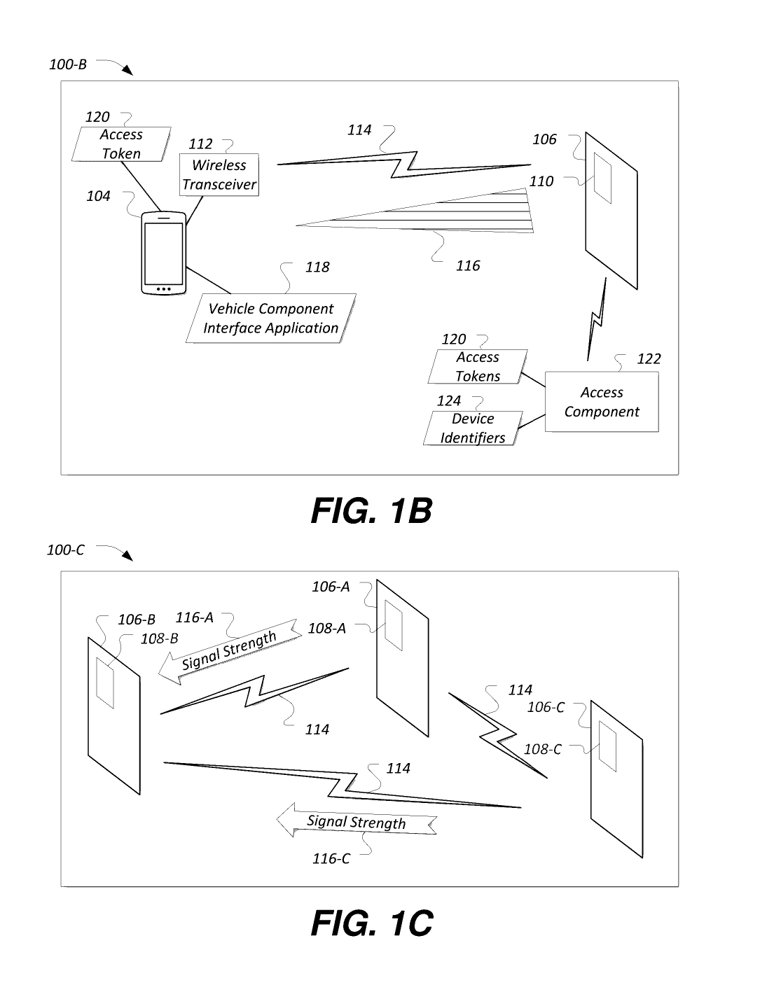

FIG. 1A illustrates an example system 100 including a vehicle 102 having a mesh of in-vehicle components 106 configured to locate and interact with users and personal devices 104 of the users. The system 100 may be configured to allow the users, such as vehicle occupants, to seamlessly interact with the in-vehicle components 106 in the vehicle 102 or with any other framework-enabled vehicle 102. Moreover, the interaction may be performed without requiring the personal devices 104 to have been paired with or be in communication with a head unit or other centralized computing platform of the vehicle 102.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). As the type and configuration of vehicle 102 may vary, the capabilities of the vehicle 102 may correspondingly vary. As some other possibilities, vehicles 102 may have different capabilities with respect to passenger capacity, towing ability and capacity, and storage volume.

The personal devices 104-A, 104-B and 104-C (collectively 104) may include mobile devices of the users, and/or wearable devices of the users. The mobile devices may be any of various types of portable computing device, such as cellular phones, tablet computers, smart watches, laptop computers, portable music players, or other devices capable of networked communication with other mobile devices. The wearable devices may include, as some non-limiting examples, smartwatches, smart glasses, fitness bands, control rings, or other personal mobility or accessory device designed to be worn and to communicate with the user's mobile device.

The in-vehicle components 106-A through 106-N (collectively 106) may include various elements of the vehicle 102 having user-configurable settings. These in-vehicle components 106 may include, as some examples, overhead light in-vehicle components 106-A through 106-D, climate control in-vehicle components 106-E and 106-F, seat control in-vehicle components 106-G through 106-J, and speaker in-vehicle components 106-K through 106-N. Other examples of in-vehicle components 106 are possible as well, such as rear seat entertainment screens or automated window shades. In many cases, the in-vehicle component 106 may expose controls such as buttons, sliders, and touchscreens that may be used by the user to configure the particular settings of the in-vehicle component 106. As some possibilities, the controls of the in-vehicle component 106 may allow the user to set a lighting level of a light control, set a temperature of a climate control, set a volume and source of audio for a speaker, and set a position of a seat.

The vehicle 102 interior may be divided into multiple zones 108, where each zone 108 may be associated with a seating position within the vehicle 102 interior. For instance, the front row of the illustrated vehicle 102 may include a first zone 108-A associated with the driver seating position, and a second zone 108-B associated with a front passenger seating position. The second row of the illustrated vehicle 102 may include a third zone 108-C associated with a driver-side rear seating position and a fourth zone 108-D associated with a passenger-side rear seating position. Variations on the number and arrangement of zones 108 are possible. For instance, an alternate second row may include an additional fifth zone 108 of a second-row middle seating position (not shown). Four occupants are illustrated as being inside the example vehicle 102, three of whom are using personal devices 104. A driver occupant in the zone 108-A is not using a personal device 104. A front passenger occupant in the zone 108-B is using the personal device 104-A. A rear driver-side passenger occupant in the zone 108-C is using the personal device 104-B. A rear passenger-side passenger occupant in the zone 108-D is using the personal device 104-C.

Each of the various in-vehicle components 106 present in the vehicle 102 interior may be associated with the one or more of the zones 108. As some examples, the in-vehicle components 106 may be associated with the zone 108 in which the respective in-vehicle component 106 is located and/or the one (or more) of the zones 108 that is controlled by the respective in-vehicle component 106. For instance, the light in-vehicle component 106-C accessible by the front passenger may be associated with the second zone 108-B, while the light in-vehicle component 106-D accessible by passenger-side rear may be associated with the fourth zone 108-D. It should be noted that the illustrated portion of the vehicle 102 in FIG. 1A is merely an example, and more, fewer, and/or differently located in-vehicle components 106 and zones 108 may be used.

Referring to FIG. 1B, each in-vehicle component 106 may be equipped with a wireless transceiver 110 configured to facilitate detection of and identify proximity of the personal devices 104. In an example, the wireless transceiver 110 may include a wireless device, such as a Bluetooth Low Energy transceiver configured to enable low energy Bluetooth signal intensity as a locator, to determine the proximity of the personal devices 104. Detection of proximity of the personal device 104 by the wireless transceiver 110 may, in an example, cause a vehicle component interface application 118 of the detected personal device 104 to be activated.

In many examples the personal devices 104 may include a wireless transceiver 112 (e.g., a BLUETOOTH module, a ZIGBEE transceiver, a Wi-Fi transceiver, an IrDA transceiver, an RFID transceiver, etc.) configured to communicate with other compatible devices. In an example, the wireless transceiver 112 of the personal device 104 may communicate data with the wireless transceiver 110 of the in-vehicle component 106 over a wireless connection 114. In another example, a wireless transceiver 112 of a wearable personal device 104 may communicate data with a wireless transceiver 112 of a mobile personal device 104 over a wireless connection 114. The wireless connections 114 may be a Bluetooth Low Energy (BLE) connection, but other types of local wireless connection 114, such as Wi-Fi or Zigbee may be utilized as well.

The personal devices 104 may also include a device modem configured to facilitate communication of the personal devices 104 with other devices over a communications network. The communications network may provide communications services, such as packet-switched network services (e.g., Internet access, VoIP communication services), to devices connected to the communications network. An example of a communications network may include a cellular telephone network. To facilitate the communications over the communications network, personal devices 104 may be associated with unique device identifiers 124 (e.g., mobile device numbers (MDNs), Internet protocol (IP) addresses, identifiers of the device modems, etc.) to identify the communications of the personal devices 104 over the communications network. These personal device identifiers 124 may also be utilized by the in-vehicle component 106 to identify the personal devices 104.

The vehicle component interface application 118 may be an application installed to a memory or other storage of the personal device 104. The vehicle component interface application 118 may be configured to facilitate vehicle occupant access to features of the in-vehicle components 106 exposed for networked configuration via the wireless transceiver 110. In some cases, the vehicle component interface application 118 may be configured to identify the available in-vehicle components 106, identify the available features and current settings of the identified in-vehicle components 106, and determine which of the available in-vehicle components 106 are within proximity to the vehicle occupant (e.g., in the same zone 108 as the location of the personal device 104). The vehicle component interface application 118 may be further configured to display a user interface descriptive of the available features, receive user input, and provide commands based on the user input to allow the user to control the features of the in-vehicle components 106. Thus, the system 100 may be configured to allow vehicle occupants to seamlessly interact with the in-vehicle components 106 in the vehicle 102, without requiring the personal devices 104 to have been paired with or be in communication with a head unit of the vehicle 102.

The system 100 may use one or more device location-tracking techniques to identify the zone 108 in which the personal device 104 is located. Location-tracking techniques may be classified depending on whether the estimate is based on proximity, angulation or lateration. Proximity methods are “coarse-grained,” and may provide information regarding whether a target is within a predefined range but they do not provide an exact location of the target. Angulation methods estimate a position of the target according to angles between the target and reference locations. Lateration provide an estimate of the target location, starting from available distances between target and references. The distance of the target from a reference can be obtained from a measurement of signal strength 116 over the wireless connection 114 between the wireless transceiver 110 of the in-vehicle component 106 and the wireless transceiver 112 of the personal device 104, or from a time measurement of either arrival (TOA) or difference of arrival (TDOA).

One of the advantages of lateration using signal strength 116 is that it can leverage the already-existing received signal strength indication (RSSI) signal strength 116 information available in many communication protocols. For example, iBeacon uses the RSSI signal strength 116 information available in the Bluetooth Low-Energy (BLE) protocol to infer the distance of a beacon from a personal device 104 (i.e. a target), so that specific events can be triggered as the personal device 104 approaches the beacon. Other implementations expand on the concept, leveraging multiple references to estimate the location of the target. When the distance from three reference beacons are known, the location can be estimated in full (trilateration) from the following equations:

d₁²=(x−x₁)²+(y−y₁)²+(z−z₁)²

d₂²=(x−x₂)²+(y−y₂)²+(z−z₂)²

d₃²=(x−x₃)²+(y−y₃)²+(z−z₃)² (1)

In an example, as shown in FIG. 1C, an in-vehicle component 106-B (or as explained below, the access component 122) may broadcast or otherwise send a request for signal strength 116 to other in-vehicle components 106-A and 106-C of the vehicle 102. This request may cause the other in-vehicle components 106-A and 106-C to return wireless signal strength 116 data identified by their respective wireless transceiver 110 for whatever devices they detect (e.g., signal strength 116-A for the personal device 104 identified by the wireless transceiver 110-A, signal strength 116-C for the personal device 104 identified by the wireless transceiver 110-C). Using these signal strengths 116-A and 116-C, as well as signal strength 116-B determined by the in-vehicle component 106-B using its wireless transceiver 110-B, the in-vehicle component 106-B may use the equations (1) to perform trilateration and locate the personal device 104. As another possibility, the in-vehicle component 106 may identify the personal device 104 with the highest signal strength 116 at the in-vehicle component 106 as being the personal device 104 within the zone 108 as follows:

$$Personal Device = i ⇒ {max}_{i = 1 , n} {RSSI}_{i} \qquad ( 2 )$$

In addition to determining in which zone 108 each personal device 104 is located (or which zone 108 is closest), the mesh of in-vehicle components 106 and the personal devices 104 may be utilized to allow the in-vehicle components 106 to identify whether the personal device 104 is located inside or outside of the vehicle, As one example, signal strengths 116 may be received from in-vehicle components 106, located in each of zones 108-A, 108-B, 108-C and 108-D. An average of the signal strengths 116 may be compared to a constant value k, such that if the average signal strength 116 exceeds the value k, then the personal device 104 is deemed to be within the vehicle 102, and if the average signal strength 116 does not exceed the value k, then the personal device 104 is deemed to be outside the vehicle 102.

Change in the signal strengths 116 may also be used to determine whether the personal device 104 is approaching the vehicle 102 or departing from the vehicle 102. As an example, if the average of the signal strengths 116 previously below an approach threshold signal level t becomes greater than the approach threshold signal level t, the personal device 104 may be detected as having approached the vehicle 102. Similarly, if the average of the signal strengths 116 previously above an approach threshold signal level t becomes less than the approach threshold signal level t, the personal device 104 may be detected as having departed from the vehicle 102.

Referring back to FIG. 1B, the access token 120 may be an arbitrary data element. The access token 120 may be received from the vehicle 102 when the user enters the vehicle 102, and may be stored to a memory or other storage device of the personal device 104. The access token 120 may be retrieved from the storage and provided by the personal device 104 back to the vehicle 102 to facilitate re-entry of the user to the vehicle 102.

The access component 122 may include one or more devices of the vehicle 102 configured to facilitate access to the vehicle 102. In an example, the access component 122 may include a dedicated system configured to handle vehicle 102 access using the access tokens 120. In another example, the access component 122 may be integrated into a module already present in the vehicle 102, such as a body controller of the vehicle 102 configured to handle door locking, security alarms, engine immobilizer control, keypad entry, or other vehicle 102 access and/or security functions. As another possibility, access component 122 may be implemented as an aspect of one of the in-vehicle components 106 (e.g., a light or other of the in-vehicle components 106 having sufficient processing capability) to reduce implementation complexity and cost.

The access component 122 may be configured to generate the access token 120 to be provided to the personal device 104. In an example, the access token 120 may be generated by performing a hashing of random information generated from information of the vehicle 102 (e.g., serial numbers or other unique identifiers 124 of in-vehicle components 106, vehicle identification number (VIN), or other vehicle 102 information or identifiers). Additionally or alternately, the access token 120 may be generated by hashing one or more identifiers or random data maintained by the personal device 104 in storage. Additionally or alternately, the access token 120 may be generated by hashing a time stamp generated at the time the access token 120 is generated and an estimated coordinate location of the personal device 104.

The access component 122 may also be configured to maintain the generated access tokens 120. In an example, the access component 122 may maintain an association of the device identifiers 124 of personal devices 104 and the access codes 120 previously provided to the personal devices 104. The access component 122 may use the stored device identifiers 124 and access codes 120 to confirm that the device identifiers 124 of the personal device 104 is authorized to provide the access code 120 that is provided. If a personal device 104 attempts to use an access code 120 associated with a device identifier 124, the access component 122 may raise an alert (e.g., sound an alarm, lock all vehicle 102 doors, contact a remote telematics service, etc.) The access component 122 may also maintain expired access codes 120, and may raise the alert when an expired access code 120 is presented to the vehicle 102.

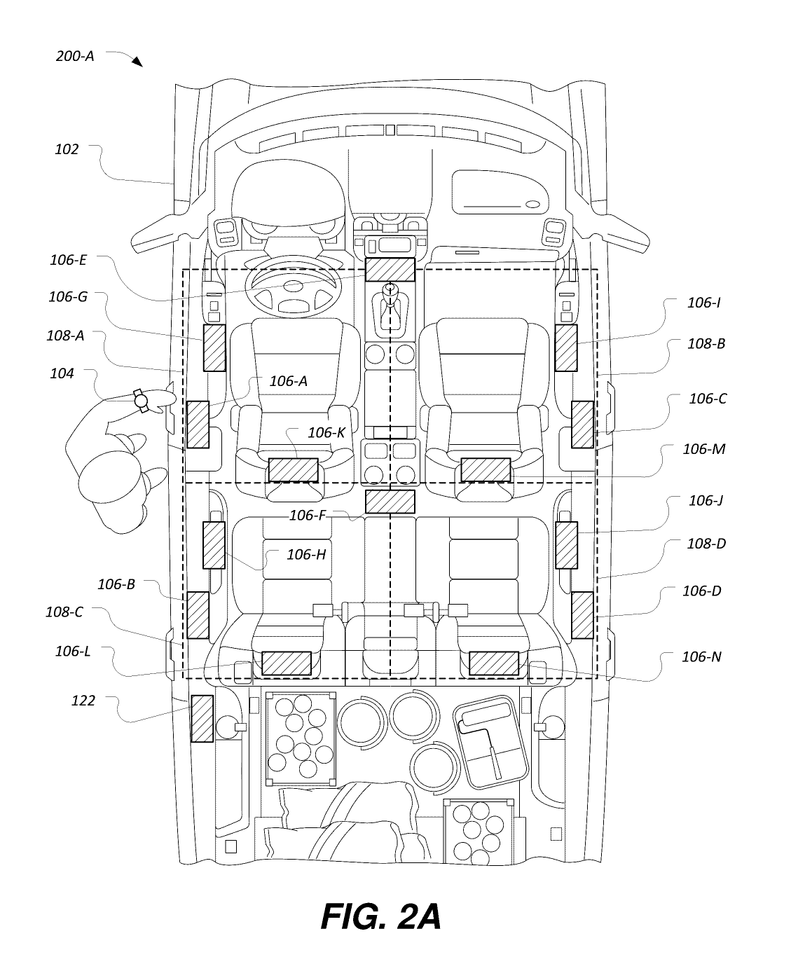

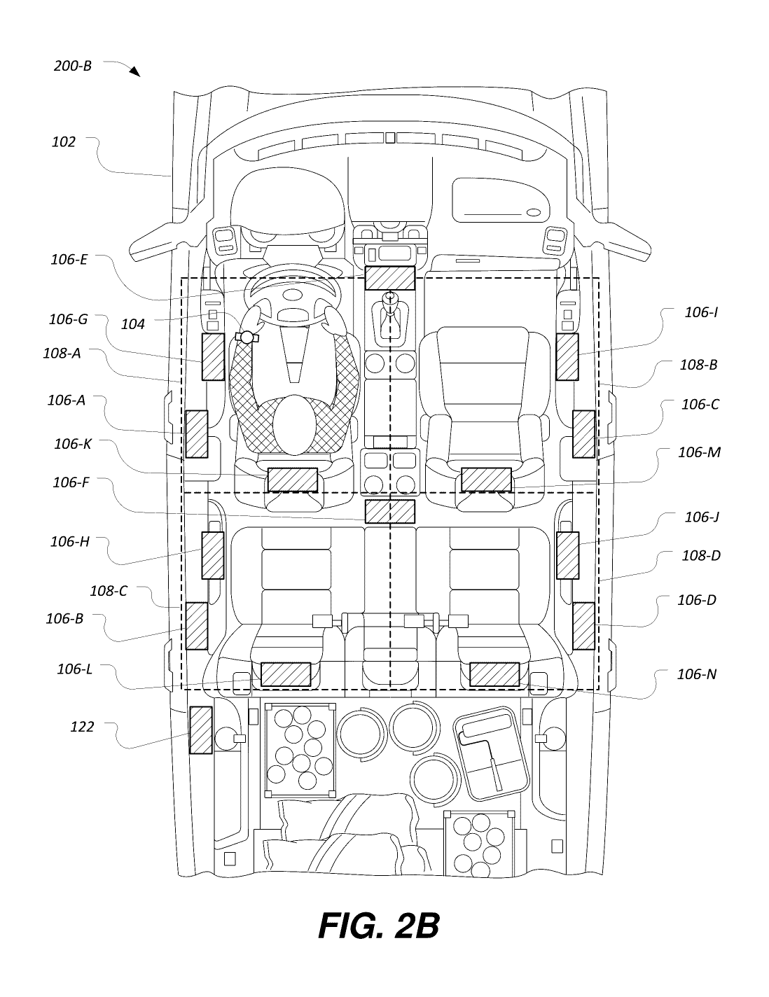

FIG. 2A illustrates an example diagram 200-A of a user carrying a personal device 104 lacking an access token 120 attempting entry to the vehicle 102. In an example, the personal device 104 may have never before been encountered by the mesh of in-vehicle components 106. In another example, the personal device 104 may have been previously encountered by the mesh of in-vehicle components 106, but may no longer be authorized to the vehicle 102. Situations in which the personal device 104 is detected but does not have an access token 120 with access rights to the vehicle 102 may be referred to as a first-time access.

In order for the user of the personal device 104 to be granted first-time access to the vehicle 102, the user may be required to authenticate with the vehicle 102 using an authentication mechanism other than use of the access token 120. As some examples, the user may utilize a key, a key-fob, entry of a passcode into a vehicle keypad, or some other type of access method for the vehicle 102. In many cases, these authentications may be performed by way of the access component 122. In other cases, the authentications may be performed by another module, such as by the body controller, and the access component 122 may be notified of the authentication. Regardless of approach, the user may accordingly be granted access to the vehicle 102, and may enter the vehicle 102 to one of the zones 108.

FIG. 2B illustrates an example diagram 200-B of the user carrying the personal device 104 having entered the vehicle 102. As the personal device 104 is recognized to be inside the vehicle 102, an access token 120 may be generated by the access component 122, and sent from the access component 122 to the personal device 104. The personal device 104 may receive the access token 120 granting the user of the personal device 104 access rights to re-enter the vehicle 102 at a later time. The access component 122 may maintain the access token 120 in association with a device identifier 124 of the personal device 104.

The access token 120 may be sent to the personal device 104 through various approaches. In an example, the access token 120 may be sent by the access component 122 to the personal device 104 using the wireless transceiver 110 of the access component 122. As another example, the access token 120 may be sent by the access component 122 to another of the in-vehicle components 106 (e.g., an in-vehicle component 106 within the zone 108 of the personal device 104), and that in-vehicle components 106 may in turn forward the access token 120 to the personal device 104. As another possibility, the access token 120 may be sent to the personal device 104 when the vehicle 102 is in motion. Because the wireless signal transmitting the access token 120 is short range, and is sent from inside an enclosed and moving vehicle 102, it may be difficult for a third party to intercept the access token 120 transmission.

The access token 120 may provide access rights that that are set based on the zone 108 of the user. As an example, if the user is located within the driver zone 108-A or, as another possibility, within the front row of the vehicle 102, the access token 120 may provide the user with access rights to re-enter the front row and other rows of the vehicle 102. As another example, if the user is located within the second row (e.g., zones 108-C or 108-D), the access token 120 may provide the user with access rights to re-enter the second row but not the front row. Additionally or alternately, the access rights of the access token 120 may be set according to settings of the vehicle 102. For instance, the access rights settings may be configured by a user operating the vehicle component interface application 118 on the personal device 104 of a device identified by the access component 122 as the owner device.

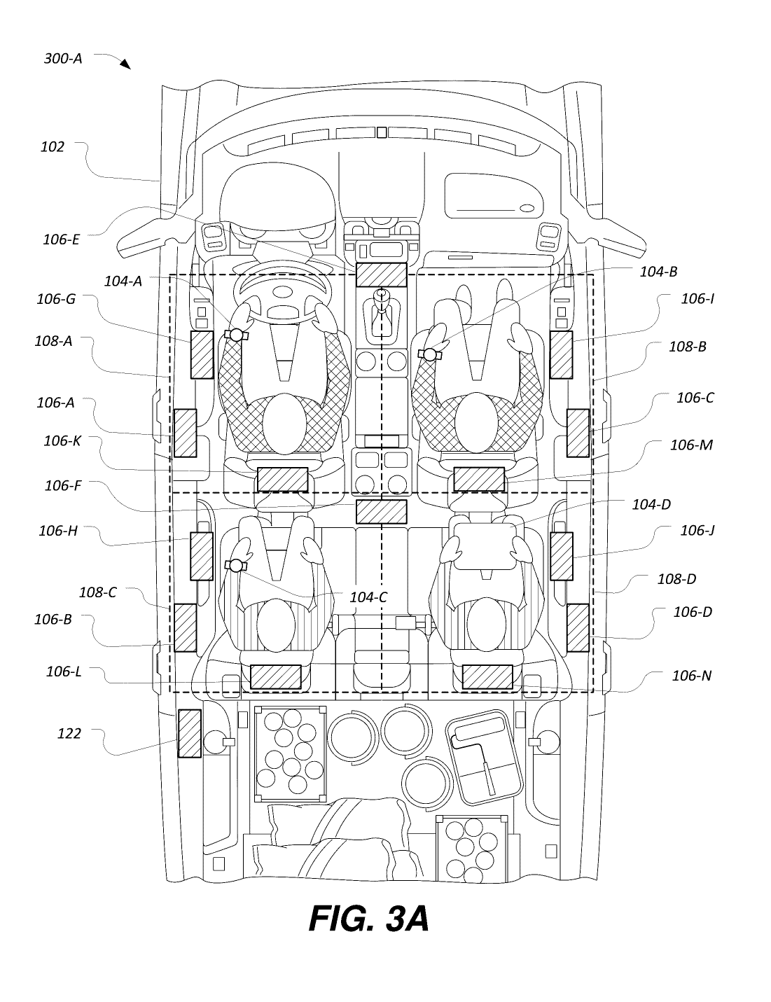

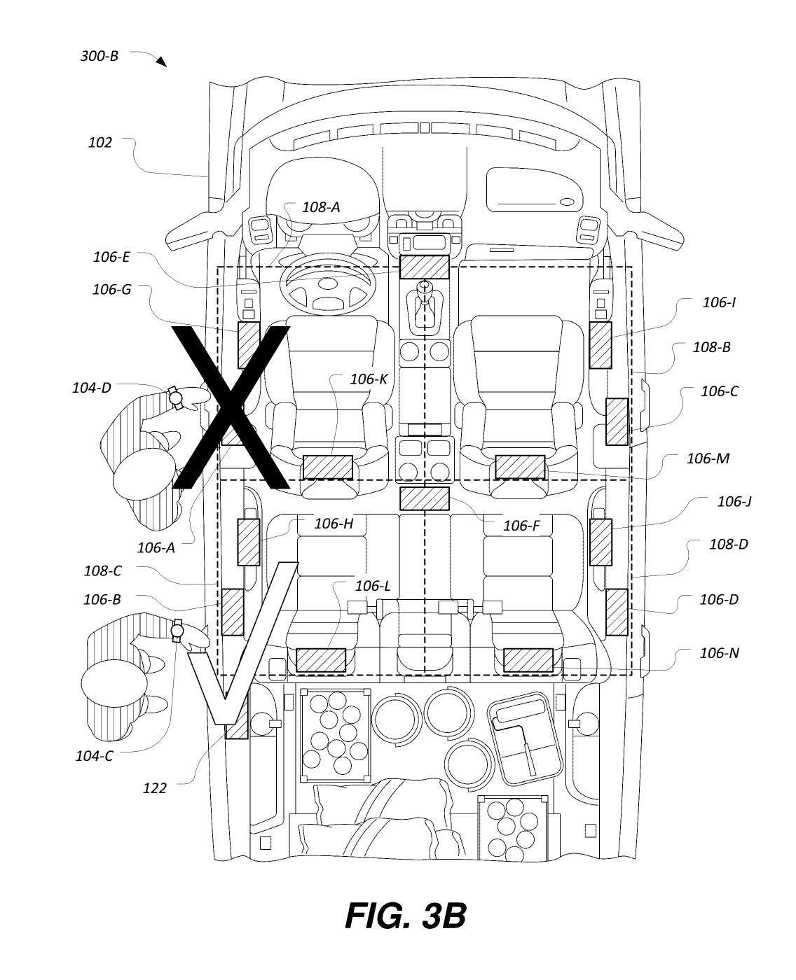

FIG. 3A illustrates an example diagram 300-A of multiple users within the vehicle 102 having personal devices 104 with access tokens 120 granting the personal devices 104 different levels of access rights to the vehicle 102. The access token 120 may provide access rights that can be set depending on the zone 108 of the user and according to the owner-preferred settings of the vehicle 102.

As shown, the driver sitting in zone 108-A of the front row of the vehicle 102 and having personal device 104-A may be provided by the access component 122 with an access token 120 to the personal device 104-A granting access to the front and rear rows of the vehicle 102. Similarly, the front passenger in zone 108-B having personal device 104-B may also be provided with an access token 120 to the personal device 104-B granting access to the front and rear rows of the vehicle 102. The rear driver side passenger having personal device 104-C may be provided by the access component 122 with an access token 120 to the personal device 104-C granting more limited access to the rear row of the vehicle 102 but not to the front row of the vehicle 102. Similarly, the rear passenger side passenger having personal device 104-D may also be provided with an access token 120 to the personal device 104-D granting access to the rear row of the vehicle 102 but not to the front row of the vehicle 102. The access tokens 120 may be used by the users to re-enter the vehicle 102 in accordance with the specified permissions.

FIG. 3B illustrates an example diagram 300-B of users attempting to regain access to the vehicle 102. For sake of explanation, the rear driver side passenger having personal device 104-C and the rear passenger side passenger having personal device 104-D may attempt to re-enter the vehicle 102. As shown, the user carrying the personal device 104-C attempts re-entry to a rear door of the vehicle 102, while the passenger carrying the personal device 104-D attempts re-entry to a front door of the vehicle 102.

The mesh of in-vehicle components 106 may be used to detect the proximity of the returning users. In an example, the access component 122 may use the signal strength 116 information from the in-vehicle components 106 to identify a target door of the vehicle 102 to which the approaching user is closest. In another example, the access component 122 may identify the target door based on a user presence at a capacitive handle of the vehicle 102, and the identity of the personal device 104 closest to that door handle may be determined responsive to the detection of the user by the door handle. In ye a further example, the access component 122 may determine an angle of approach or target door based on an analysis of the change in signal strength 116 information from the personal device 104 over time. For example, a plurality of positions of the personal device 104 may be captured over time, and a trajectory may be extrapolated by the access component 122 based on a continuation of a trend identified by the plurality of positions.

Responsive to the determination of the returning user and the target door, the access component 122 may determine a request to unlock the target door. In an example, the request may be identified responsive to confirmation of motion is sensed by both hardware sensors on the personal device 104 and by triangulation with the in-vehicle components 106 to confirm that the personal device 104 is in fact located by the target door. The access component 122 of the vehicle 102 may match the access code 120 with the device identifier 124 of the personal device 104, and may decide whether to grant or deny access to the vehicle 102 via the target door.

As shown, the passenger carrying the personal device 104-C and attempting re-entry to the rear of the vehicle 102 may be granted access according to the access token 120 of the personal device 104-C, and the passenger carrying the personal device 104-D and attempting re-entry to the front of the vehicle 102 may be denied access according to the access token 120 of the personal device 104-D, as such access exceeds that specified by the access token 120 of the personal device 104-D.

For the passenger carrying the personal device 104-C, when access is granted the one-time access token 120 may be consumed and a new access token 120 issued by the access component 122. The access component 122 may base the new access token 120 on the data of the old access token 120, or in other examples the access component 122 may generate the new access token 120 without using the data of the old access token 120. As the access token 120 is changed for each use with the vehicle 102, an attempt to break the encryption of the access token 120 may be difficult for a potential attacker.

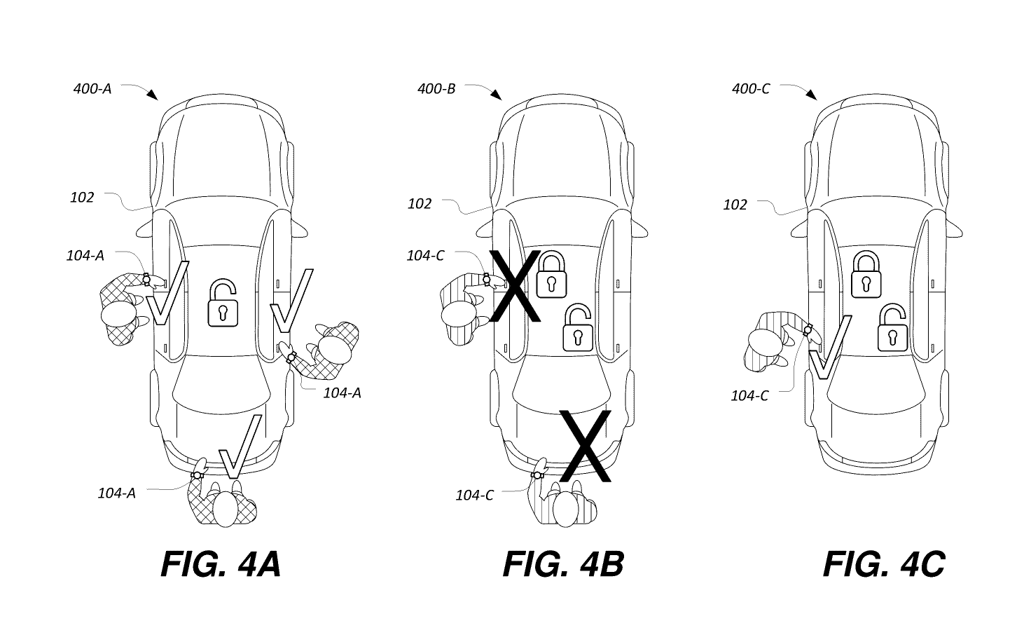

Because the in-vehicle components 106 can provide signal strength 116 information used to determine where the personal device 104 is located (and, if moving, the direction of approach), the doors such as a lift-gate or trunk-lid may be easily opened on approach as shown in FIGS. 4A-4C. Whether the requested open action is performed may depends on the access rights of the access token 120 provided to the user's personal device 104 the previous time that the user's personal device 104 was detected inside the vehicle 102.

In some cases, the lift-gate door may be directed to open upon presence of the personal device 104. In other examples, a user interface interaction with the personal device 104 may be used to confirm intent to open the lift-gate. This interaction could be, as some possibilities, speaking a voice command to the personal device 104 requesting the lift-gate door be opened, pressing a button on the personal device 104, or touching a lift-gate door open soft control on a touch screen interface of the personal device 104.

The lift-gate door may be closed based on one or more criteria. These criteria may include, as some examples, the personal device 104 being detected by the in-vehicle components 106 as having entered the vehicle 102, or the personal device 104 being detected by the in-vehicle components 106 as having left proximity to the vehicle 102, or responsive to user interface interaction with the personal device 104. Similarly, this interaction could be, as some possibilities, speaking a voice command to the personal device 104 requesting the lift-gate door be closed, pressing a button on the personal device 104, or touching a lift-gate door close soft control on a touch screen interface of the personal device 104.

The lift-gate door may open when the personal device 104 provides an access code 120 that is indicates access rights to open the lift-gate door. These rights can be set temporarily depending on seating location, or by entering settings in the vehicle component interface application 118. As shown in the diagram 400-A of FIG. 4A, a front seat user having the personal device 104-A may use the access token 120 of the personal device 104-A to unlock a front door of the vehicle 102, a rear door of the vehicle 102, or the lift-gate door of the vehicle 102. As shown in the diagram 400-B of FIG. 4B, a rear seat user having the personal device 104-C may have an access token 120 denied access to the front door of the vehicle 102, or the lift-gate door of the vehicle 102, but, as shown in the diagram 400-C of FIG. 4C may be used to access the rear door of the vehicle 102.

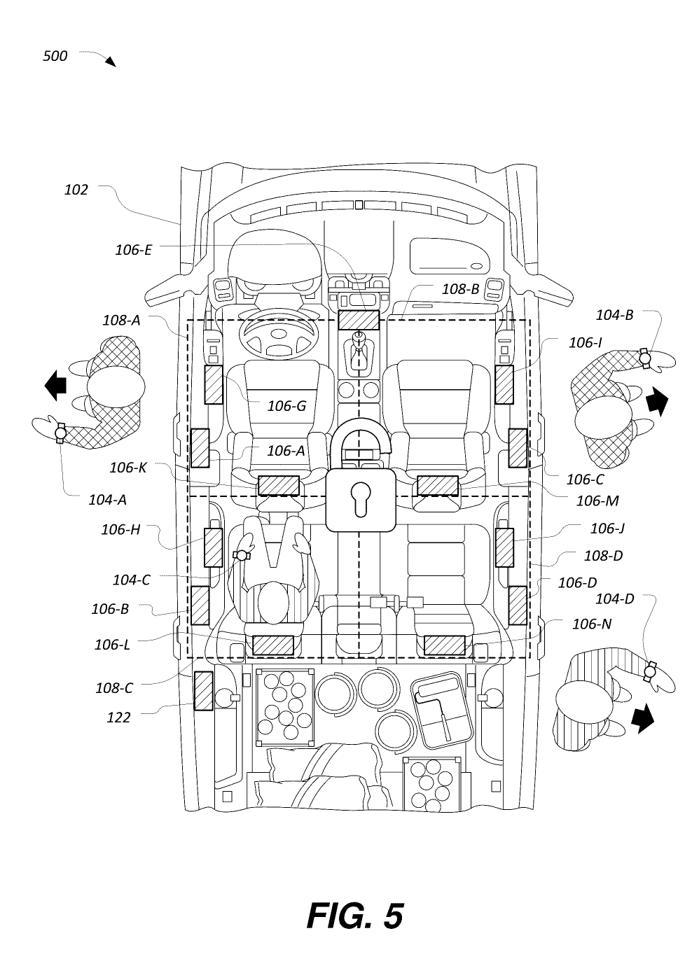

FIG. 5 illustrates an example diagram 500 of specific doors of the vehicle 102 automatically being locked when users exit the vehicle 102. For example, when the access component 122 detects using signal strength 116 information from the in-vehicle components 106 that the personal device 104 of a user leaves the vehicle 102, the door granting access to the zone 108 of the vehicle 102 from which the user departed may be automatically locked. For instance, the front driver side door may be locked responsive to the personal device 104-A departing the vehicle 102, the front passenger side door may be locked responsive to the personal device 104-B departing the vehicle 102, and the rear passenger side door may be locked responsive to the personal device 104-D departing the vehicle 102.

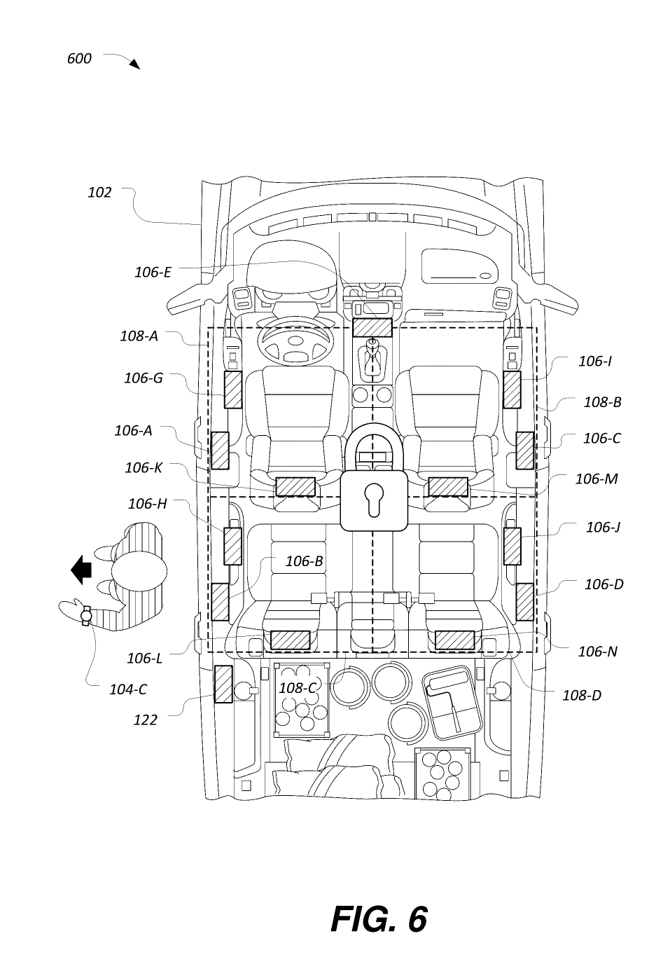

FIG. 6 illustrates an example diagram 600 of the vehicle 102 automatically being locked when the last user exits the vehicle 102. For example, when the access component 122 detects using signal strength 116 information from the in-vehicle components 106 that the last personal device 104 located within the vehicle 102 has left the vehicle 102, all doors to the vehicle 102 may be automatically locked.

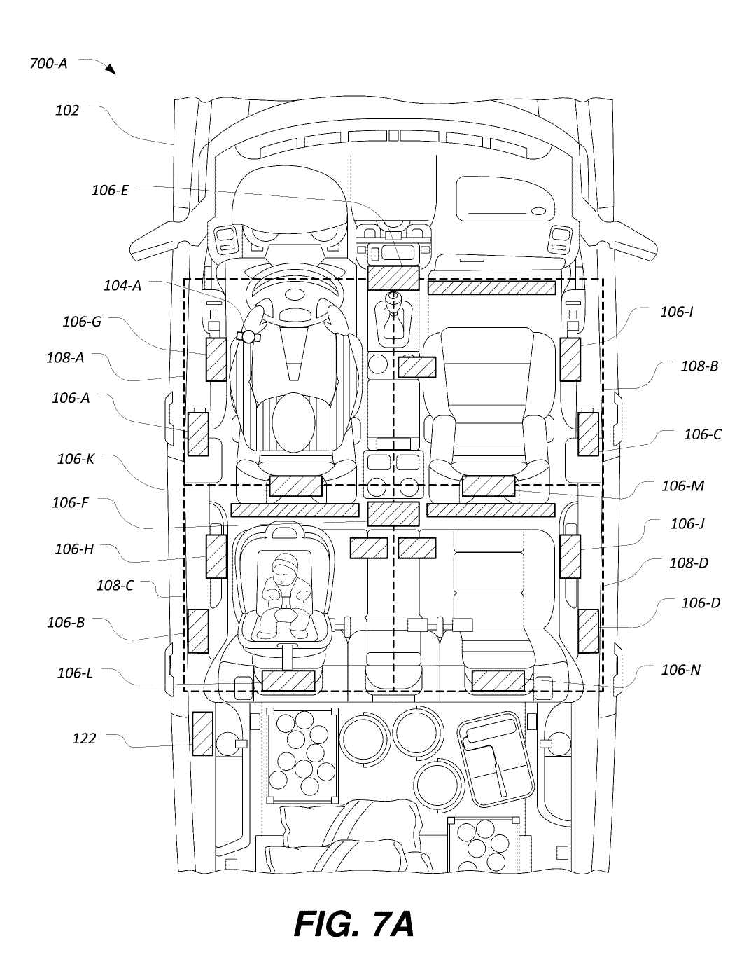

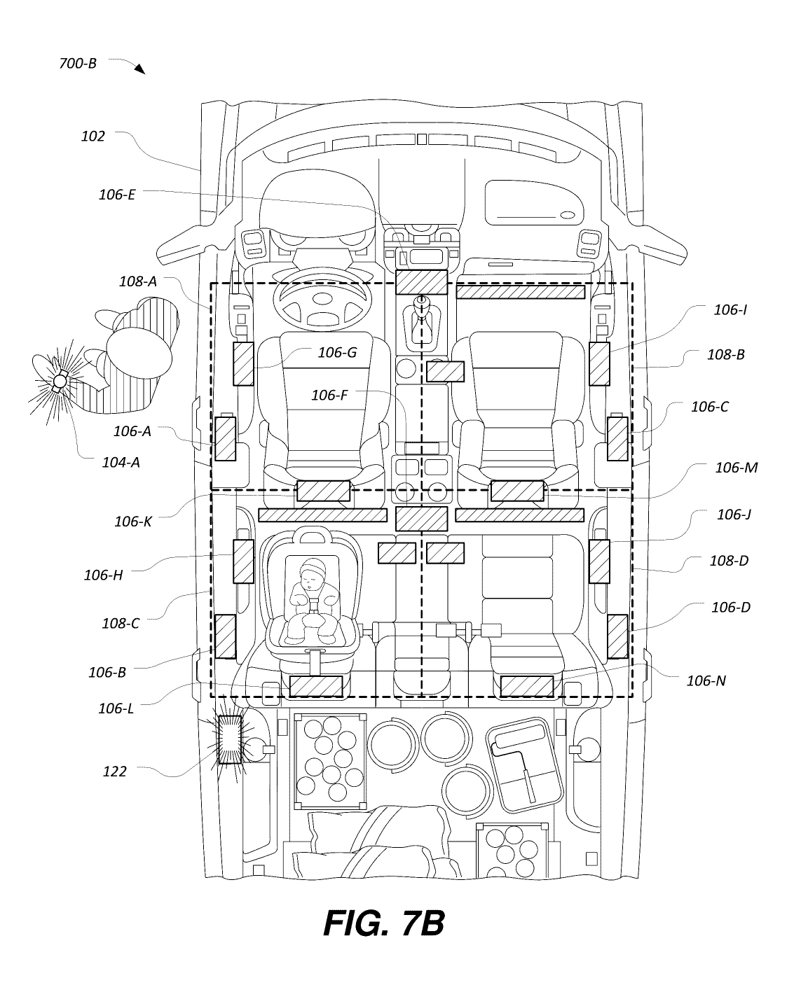

FIG. 7A illustrates an example diagram 700-A of a vehicle 102 including a user and contents to which the user may be alerted if left in the vehicle 102. As shown, a driver user is carrying a personal device 104-A, and the contents include a baby passenger is located in the rear seat zone 108-C of the vehicle 102. In another example, the contents may include a personal device 104. The access component 122 may detect the exit of the user from the vehicle 102, while the contents may not have exited. In such a situation, the access component 122 may direct the vehicle 102 to provide a warning chime or other alert if any of the in-vehicle components 106 provide the access component 122 with signal strength 116 information indicative of presence of other devices still in the vehicle, for example to warn of the child being left behind, or of a personal device 104 being forgotten in the cabin of the vehicle 102. In another example, the alert may be provided by a vehicle 102 alarm controlled by the access component 122. In another example, as shown in the FIG. 7B, the alert may be provided by the personal device 104-A of the exiting user.

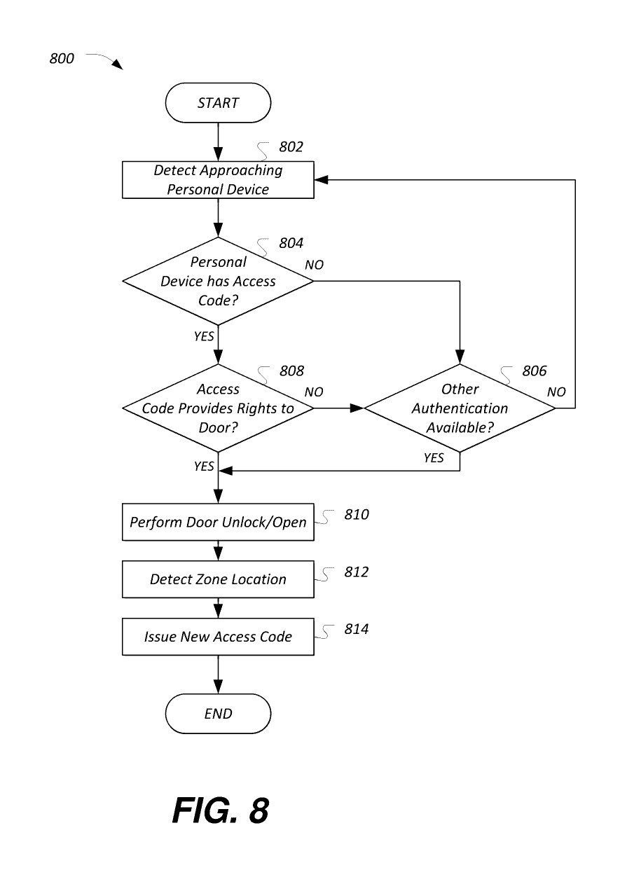

FIG. 8 illustrates an example process 800 for issuing an access token 120 to a personal device 104. In an example, the process 800 may be performed by the in-vehicle components 106 and access component 122 of the vehicle 102 in communication with one or more personal devices 104.

An approaching user is detected at 802. In an example, the access component 122 may receive signal strength 116 information from the in-vehicle components 106, and may determine an approaching personal device 104 to a target door of the vehicle 102 according to an average of the signal strengths 116 of a personal device 104 that were previously below an approach threshold signal level t becoming greater than the approach threshold signal level t. The specific target door may, in some cases, be determined based on an extrapolation of the trend of movement of the personal device 104 according to the changes in signal strengths 116. In another example, the user carrying the personal device 104 may move towards a capacitive door handle or other sensor of a target door of the vehicle 102, which may trigger the access component 122 to identify the personal device 104 located in proximity to the sensor.

At 804, the access component 122 determines whether the personal device 104 has an access code 120. In an example, responsive to determining that the personal device 104 has approached, the access component 122 may request the personal device 104 to provide an access code 120. If the personal device 104 does not respond with the access code 120 or does not respond, control passes to operation 806. Otherwise, if an access code 120 is received in response, control passes to operation 806.

At operation 806, the access component 122 determines whether other authentication mechanisms are available to grant the user access to the vehicle 102. As some possible examples, the access component 122 may receive input of a key code to a keypad of the vehicle 102, may receive a button unlock press to a key fob of the user previously paired with the access component 122 or body controller of the vehicle 102, or may receive an indication of presence of a keyless entry fob carried by the user. If the user is authenticated using another authentication mechanism, control passes to operation 810. Otherwise, control returns to operation 802 to detect approaching personal devices 104.

In the operations of 808, the access component 122 determines whether the access code 120 provides the user with rights to open the target door. In an example, the access component 122 may maintain an association of identifiers of personal devices 104 and the access codes 120 previously provided to the personal devices 104, and may confirm that the identifier of the personal device 104 is associated with the access code 120 that is provided. In another example, the access component 122 may identify the access rights associated with the access code 120 (e.g., full access, rear door access only, etc.) to determine whether the access code 120 provides rights to unlock or open the target door of the vehicle 102. If the access code 120 is provides the user with rights to open the target door, control passes to operation 810. Otherwise, control passes to operation 806.

At operation 810, the access component 122 performs the requested access action to the target door. In an example, the access component 122 may direct the target door to unlock or open. The user may accordingly be provided access to the vehicle 102. The access component 122 may further remove the access code 120 from storage as associated with the personal device 104, as the access code 120 may be single-use only, and consumed upon completion of the performance of the requested action.

The access component 122 detects the zone 108 location of the personal device 104 at operation 812. In an example, the access component 122 may receive signal strength information 116 from the in-vehicle components 116, and may use lateration or another technique to locate the zone 108 of the vehicle 102 in which the personal device 104 (and accordingly the user) is located. In another example, the user of the personal device 104 may specify or confirm the location of the user, e.g., by pressing a button on one of the in-vehicle components 106, or by selecting or confirming a location determination using the vehicle component interface application 118 of the personal device 104.

In 814, the access component 122 issues a new access code 120 to the personal device 104. For example, if the user was granted access to the vehicle 102 using an access code 120, the new access code 120 may provide the access rights (e.g., full access, rear door access only, etc.) consistent with those associated with the old access code 120. As another example, if the user was granted access to the vehicle 102 using another authentication mechanism, the new access code 120 may provide the access rights consistent with the current seating zone 108 location of the user. The user of the personal device 104 may accordingly use the new access code 120 for later re-entry to the vehicle 102. After operation 814, the process 800 ends.

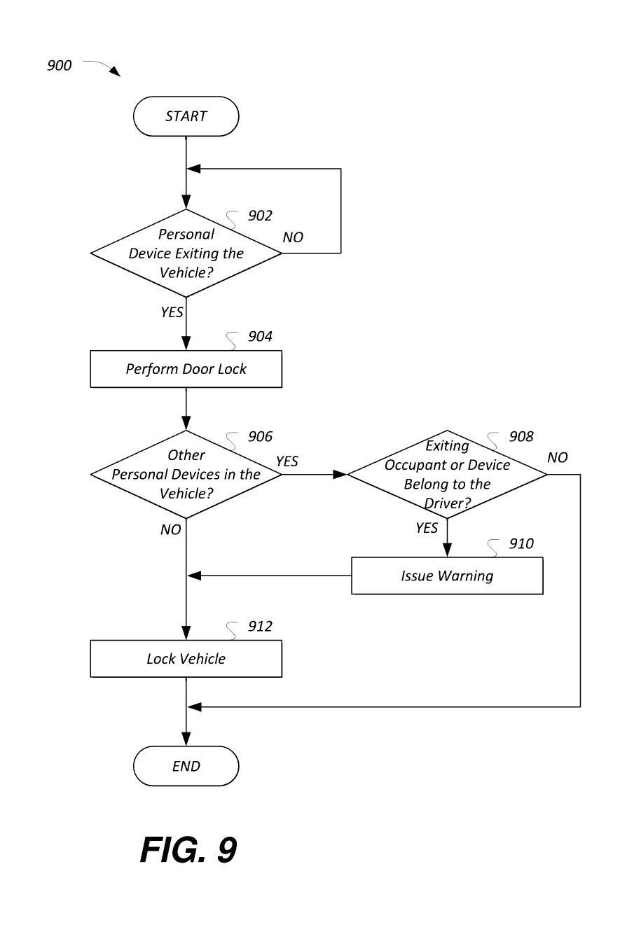

FIG. 9 illustrates an example process 900 for utilizing the access token 120 for re-entry to the vehicle 102. In an example, and similar to the process 800, the process 900 may be performed by the in-vehicle components 106 and access component 122 of the vehicle 102 in communication with one or more personal devices 104 located within the vehicle 102.

At operation 902, the access component 122 determines whether a personal device 104 is exiting the vehicle 102. As one possible example, the access component 122 may identify that a door of the vehicle 102 is opened, a personal device 104 previously detected by the in-vehicle components 106 as within the zone 108 has left the vehicle 102, and the door of the vehicle 102 is closed. If so, control passes to operation 904. Otherwise, control remains at operation 902.

At 904, the access component 122 performs a door lock of the target door of the user. For example, the door having been opened and closed when the user leaves the vehicle 102 may be locked behind the user. In an example, the lock may be performed a predetermined time period after the user closes the door (e.g., five seconds, sixty seconds, etc.). In another example, if the average of the signal strengths 116 of the personal device 104 previously above an approach threshold signal level t becomes less than the approach threshold signal level t, the personal device 104 may be detected as having departed from the vehicle 102, and the door lock may be performed.

Whether other personal devices 104 are within the vehicle 102 is determined at 906. In an example, the access component 122 may utilize signal strength information 116 from the personal devices 104 to determine whether any personal devices 104 are still indicated as being within the vehicle 102. If so, control passes to operation 908. If not, control passes to operation 912.

At operation 908, the access component 122 determines whether the occupant or personal device 104 detected as having left the vehicle at operation 902 was the driver or the personal device 104 of the driver. In an example, the access component 122 may determine whether one of the one or more personal devices 104 located within the vehicle 102 is associated with the driver zone 108-A of the vehicle 102. If so, control passes to operation 910. Otherwise, the process has determines that the driver is still inside the vehicle 102, no lock action is required for the vehicle 102, and the process 900 ends.

The access component 122 issues a warning in the operations at 910 to warn the driver that other devices, and possibly occupants, are still inside the vehicle 102. In an example, the access component 122 direct the personal device 104 of the user having exited the vehicle 102 to provide a warning chime or other alert. In another example, the alert may be provided by a vehicle 102 alarm, lights, or other vehicle 102 warning system controlled by the access component 122.

At operation 912, the access component 122 locks the vehicle 102. In an example, the access component 122 may issue a lock command a predetermined time period after the user closes the door (e.g., five seconds, sixty seconds, etc.). In another example, if the average of the signal strengths 116 of the personal device 104 previously above an approach threshold signal level t becomes less than the approach threshold signal level t, the personal device 104 may be detected as having departed from the vehicle 102, and the access component 122 may issue a lock command in response. After operation 912, the process 900 ends.

Thus, the in-vehicle components 106 may be used to allow access to a vehicle 102, including locking and unlocking of vehicle 102 doors, lift-gate and trunk lid, without the need for complex pairing and authorization procedures. The vehicle 102 may issue one-time access codes 120 each time a personal device 104 is detected inside the vehicle 102. The access codes 120 may provide access rights that depend on the zone 108 of the user and/or other system preferences.

The system may accordingly operate without need for pairing of the personal devices 104 with the vehicle 102, may provide for security as the access codes 120 may be single-use, and may support access rights localized to the zone 108 or area of the vehicle 102 to which the user had access. The system may also be able to identify whether to fully lock the vehicle 102 upon detection of exit of the user depending on presence of remaining personal devices 104 within the vehicle 102 cabin. The system may also warn exiting users whether a child carrying any type of personal device 104 is left inside the vehicle 102. The system may also warn the driver or passengers on exit if a personal device 104 is left inside the vehicle in their corresponding zone 108.

Computing devices described herein, such as the personal devices 104, in-vehicle components 106, and access component 122, generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
wireless transceivers of a vehicle; and
an access component of the vehicle, in communication with the transceivers, programmed to
detect, according to signal strength information received from the transceivers, presence of an approaching personal device,
grant access to a vehicle door responsive to a first access code received from the personal device, and
expire the first access code and issue a second access code to the personal device responsive to the grant.

2. The system of claim 1, wherein the access component is further programmed to authenticate a user of the personal device according to one or more of a key, a key-fob, or a passcode entered into a vehicle keypad responsive to the first access code failing to provide access to the vehicle door.

3. The system of claim 1, wherein the grant of access includes at least one of automatically unlocking the vehicle door or automatically opening the vehicle door.

4. The system of claim 1, wherein the first access code grants access to a subset of the vehicle doors, and the second access code grants access to the same subset of the vehicle doors.

5. The system of claim 4, wherein the subset of the vehicle doors includes rear doors of the vehicle but not front doors of the vehicle.

6. The system of claim 1, wherein the access component is further programmed to:
grant access to the vehicle via the vehicle door responsive to receiving the second access code from the personal device; and
issue a third access code and expire the second access code responsive to the grant of access responsive to receiving the second access code from the personal device.

7. The system of claim 1, wherein the access component is further programmed to lock the vehicle door responsive to detection of the personal device exiting the vehicle according to the signal strength information received from the transceivers.

8. A method comprising:
authenticating a user with a vehicle using a keyless entry device;
issuing a first access code to a personal device responsive to the authenticating;
detecting the personal device approaching a vehicle door;
granting access to the vehicle via the vehicle door responsive to receiving the first access code from the personal device; and
expiring the first access code and issuing a second access code to the personal device responsive to the granting.

9. The method of claim 8, further comprising detecting the personal device as approaching the vehicle door according to personal device signal strength information received from a plurality of wireless transceivers of the vehicle.

10. The method of claim 8, wherein granting access includes at least one of automatically unlocking the vehicle door or automatically opening the vehicle door.

11. The method of claim 8, wherein the first access code grants access to a subset of vehicle doors, and the second access code grants access to the same subset of the vehicle doors.

12. The method of claim 11, wherein the subset of the vehicle doors includes rear doors of the vehicle but not front doors of the vehicle.

13. The method of claim 8, further comprising:
granting access to the vehicle via the vehicle door responsive to receiving the second access code from the personal device; and
expiring the second access code and issuing a third access code to the personal device responsive to receiving the second access code from the personal device,
wherein the second access code grants access to a subset of vehicle doors, and the third access code grants access to the same subset of the vehicle doors.

14. The method of claim 8, further comprising locking the vehicle door responsive to detection of the personal device exiting the vehicle according to signal strength information received from a plurality of transceivers of the vehicle.

15. A system comprising:
a memory; and
a processor, in communication with the memory, programmed to
send a first access code stored to the memory to a vehicle to attempt access to the vehicle,
receive a second access code responsive to the access being granted, and
responsive to receipt of the second access code, discard the first access code and store the second access code to the memory to attempt a later access to the vehicle.

16. The system of claim 15, wherein the processor is further programmed to:
receive the first access code from the vehicle responsive to authentication with the vehicle using one or more of a key, a key-fob, or a passcode entered into a vehicle keypad; and
storing the first access code to the memory.

17. The system of claim 15, wherein the first access code is keyed to a unique identifier associated with the processor, and wherein the processor is further programmed to provide the unique identifier to the vehicle for verification of the first access code.

18. The system of claim 15, wherein the processor is further programmed to:
send the second access code to the vehicle to attempt the later access to the vehicle,
receive a third access code responsive to grant of the later access,
discard the second access code, and
store the third access code to the memory.

19. The system of claim 15, wherein the first access code grants access to a subset of doors of the vehicle, and the second access code grants access to the same subset of doors of the vehicle.
